(19) United States
(12) Patent Application Publication
(10) Pub. No.: US 2024/0176342 A1
(43) Pub. Date: May 30, 2024

(54) COMPUTER-IMPLEMENTED METHOD AND DEVICE FOR PREDICTING A STATE OF A TECHNICAL SYSTEM

(71) Applicants: Katharina Ensinger, Asperg (DE); Barbara Rakitsch, Stuttgart (DE); Karim Said Mahmoud Barsim, Stuttgart (DE); Michael Tiemann, Tuebingen (DE); Sebastian Ziesche; Sebastian Trimpe, Aachen (DE)

(72) Inventors: Katharina Ensinger, Asperg (DE); Barbara Rakitsch, Stuttgart (DE); Karim Said Mahmoud Barsim, Stuttgart (DE); Michael Tiemann, Tuebingen (DE); Sebastian Ziesche; Sebastian Trimpe, Aachen (DE)

(21) Appl. No.: 18/520,721

(22) Filed: Nov. 28, 2023

(30) Foreign Application Priority Data
Nov. 30, 2022 (DE) 102022212906.7

(51) Int. Cl. G05B 23/02

(52) U.S. Cl. CPC G05B 23/0283; G05B 23/0243; G05B 23/0264

(57) ABSTRACT

A device and computer-implemented method for predicting a state of a technical system. A state of the technical system is detected. A time series is provided which includes values which characterize a course of the detected state of the technical system. Using a first filter, first filtered values for predicting the short-term behavior of the technical system are determined as a function of the values of the time series. Using a second filter, second filtered values for predicting the long-term behavior of the technical system are determined as a function of the values of the time series. A first value for the prediction is determined as a function of the filtered first values. A second value for the prediction is determined as a function of the filtered second values. A value of the prediction is determined as a function of the first and second values for the prediction.

### FIELD

The present invention relates to a computer-implemented method and a device for predicting a state of a technical system. The prediction is made possible by learning-based methods or hybrid modeling methods.

### SUMMARY

A computer-implemented method and the device according to the present invention may enable very precise modeling of the long-term behavior without loss of precision in the modeling of the short-term behavior of a technical system.

According to an example embodiment of the present invention, the computer-implemented method for predicting a state of a technical system provides that a state of the technical system is detected and a time series is provided which comprises values which characterize a course of the detected state of the technical system, wherein, using a first filter, first filtered values for predicting the short-term behavior of the technical system are determined as a function of the values of the time series, and, using a second filter, second filtered values for predicting the long-term behavior of the technical system are determined as a function of the values of the time series, and a first value for the prediction is determined as a function of the filtered first values and a second value for the prediction is determined as a function of the filtered second values, wherein a value of the prediction is determined as a function of the first value for the prediction and the second value for the prediction. This uses a decomposition into two filtered time series to determine the prediction with reliable behavior.

According to an example embodiment of the present invention, it is preferably provided that the first filter is a filter that is complementary to the second filter, in particular is complementary to a low-pass filter; in particular, the first filter is a high-pass filter. This uses a decomposition into a complementary high-pass and low-pass component in order to determine the prediction with reliable long-term and short-term behavior. The long-term behavior is based on the low-pass component and the short-term behavior on the high-pass component.

Preferably, according to an example embodiment of the present invention, the low-pass filter has a cut-off frequency, wherein the high-pass filter has the cut-off frequency or has a higher cut-off frequency than the low-pass filter. This uses a decomposition into specified different frequency ranges in order to determine the prediction with reliable long-term and short-term behavior.

Preferably, according to an example embodiment of the present invention, sampled values are determined by means of sampling, in particular the k-th, of the filtered second values at a sampling rate, in particular k, wherein the second value for the prediction is determined as a function of the sampled values. By sampling, fewer computing resources are required than without sampling. This enables an implementation using hardware that has fewer computing resources. The sampled values are preferably interpolated in order to obtain a corrected time series without artifacts with unwanted frequency components.

According to an example embodiment of the present invention, the first filtered values are preferably mapped to the first value using a first model, while the sampled values are mapped to the second value using a second model.

Preferably, according to an example embodiment of the present invention, the first model is trained as a function of a first time series, wherein the first time series is determined, using the first filter, as a function of a time series which represents a temporal progression of the state of the technical system, wherein the second model is trained as a function of a second time series, wherein a filtered time series is determined, using the second filter, as a function of the time series, wherein the second time series comprises values sampled from the filtered time series at the sampling rate. The first model is trained for the prediction of the short-term behavior. The second model is trained for the prediction of the long-term behavior.

Preferably, according to an example embodiment of the present invention, the value of the prediction is determined as a function of a sum of the first value for the prediction and the second value for the prediction. The resulting prediction includes both components, in particular for the short-term and the long-term prediction.

Preferably, according to an example embodiment of the present invention, a parameter for the operation of the technical system or a long-term behavior of the technical system is determined as a function of the prediction.

According to an example embodiment of the present invention, the device for predicting a state of a technical system comprises at least one processor and at least one memory, wherein the at least one processor is designed to execute machine-readable instructions, the execution of which by the processor causes the method to run.

Preferably, according to an example embodiment of the present invention, the device comprises a sensor for detecting sensor data or an interface for communicating with a sensor for detecting sensor data, wherein the sensor data comprise a course of a state of the technical system.

According to an example embodiment of the present invention, a program can be provided that comprises computer-readable instructions, the execution of which by a computer causes the method to run.

Further advantageous embodiments of the present invention can be found in the following description and the figures.

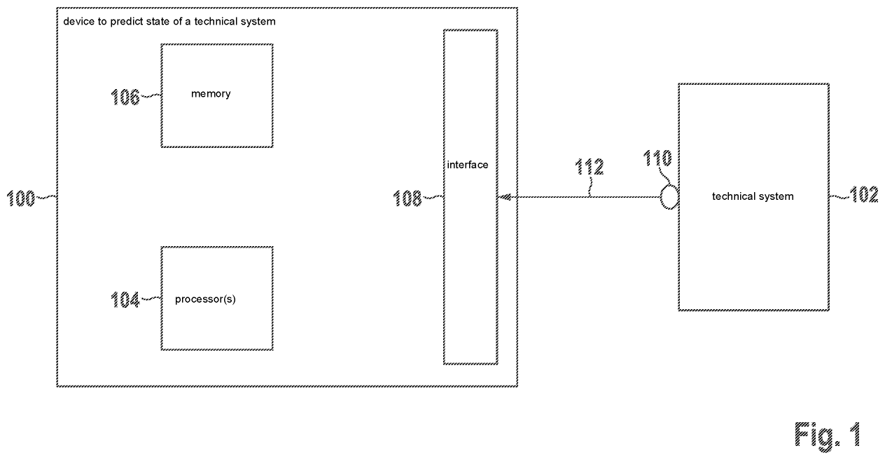

FIG. 1 shows a schematic view of a device for predicting a state of a technical system, according to an example embodiment of the present invention.

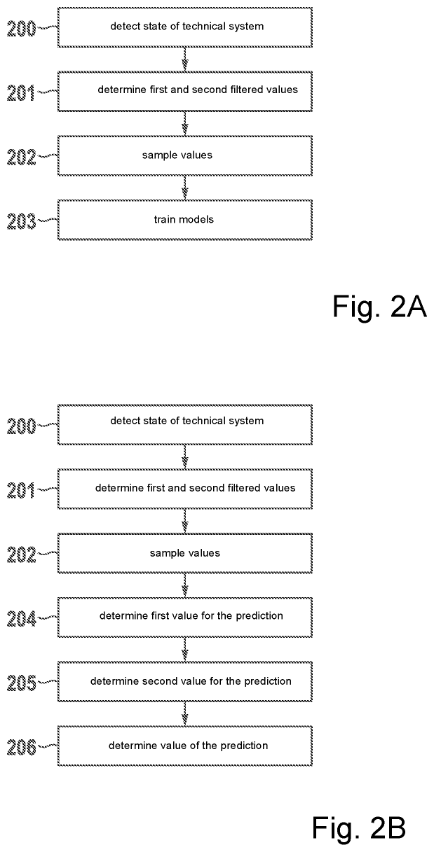

FIG. 2A shows steps for training models for predicting the state of the technical system, according to an example embodiment of the present invention.

FIG. 2B shows steps for predicting the state of the technical system using the models, according to an example embodiment of the present invention.

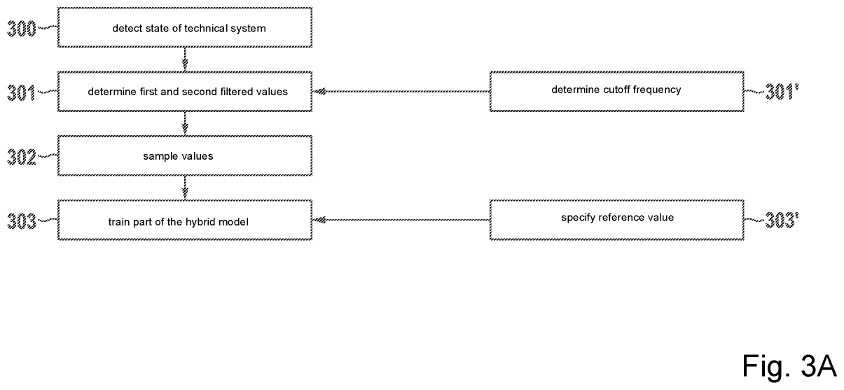

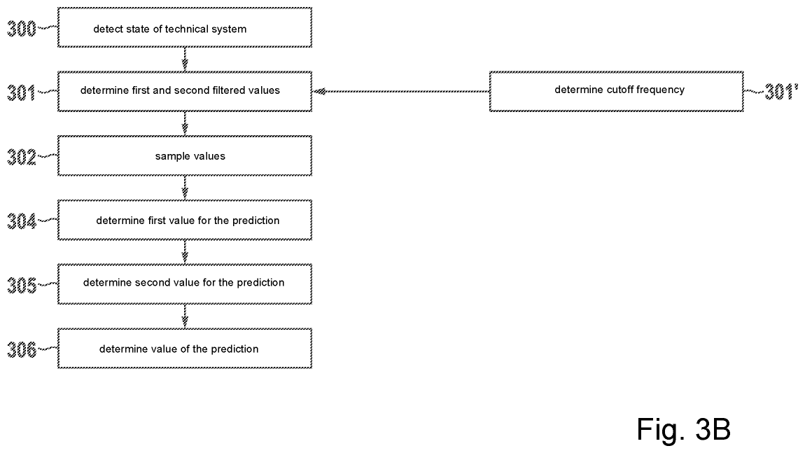

FIG. 3A shows steps for training a hybrid model for predicting the state of the technical system, according to an example embodiment of the present invention.

FIG. 3B shows steps for predicting the state of the technical system using the hybrid model, according to an example embodiment of the present invention.

### DETAILED DESCRIPTION OF EXAMPLE EMBODIMENTS

FIG. 1 schematically shows a device 100 for predicting a state of a technical system 102. The technical system 102 is a really existing system. The technical system 102 is a physical system. For example, the technical system 102 is a robotic device. For example, the technical system 102 is a robot. For example, the technical system 102 is a vehicle, a power tool, a production machine, a household appliance, an access control system, or a personal assistance system.

The device 100 comprises at least one processor 104 and at least one memory 106. In the example, the device 100 comprises an interface 108 for communicating with a sensor 110 for detecting sensor data 112. The device 100 can comprise the sensor 110.

The sensor data 112 detect a course of a state of the technical system 102.

The course relates, for example, to a position or an energy consumption of the technical system 102, thermal data about the technical system 102, or electrical or mechanical variables.

The sensor 110 comprises, for example, an acceleration sensor or a rotation rate sensor. The state predicted by the prediction is, for example, a position of the technical system 102 in space.

The at least one processor 104 is designed to execute machine-readable instructions, the execution of which by the processor 104 causes a method described below to run.

The method provides, for example, that a future state of the technical system 102 is predicted based on a short time interval of measurement data from the sensor 110. This is important, for example, in order to simulate the state in different scenarios and thus to find the best parameters for operation of the technical system 102.

For example, the method provides that a parameter for the operation of the technical system 102 is determined as a function of the prediction.

The long-term behavior is determined, for example, for different settings of the technical system 102, i.e. for example settings with different parameters.

The parameter for the operation of the technical system 102 is, for example, a controller parameter, in particular a gain or dead time, for a controller for controlling the technical system 102.

For example, the technical system 102 is controlled by the controller as a function of the prediction of the state.

For example, the position of the technical system 102 in space, in particular with a drive for moving the technical system 102 in space, is controlled as a function of the prediction for the position.

Using the method, through repeated execution of the prediction for determining a time series, which comprises values of the prediction that build on one another, in particular a long-term behavior of the technical system is robustly predicted.

For example, the method provides that a long-term behavior of the technical system 102 is determined as a function of the prediction.

For example, wear of the technical system 102 is determined as a function of the prediction of the state.

For example, wear of the technical system 102 is determined as a function of the prediction of the long-term behavior.

The at least one memory 104 comprises e.g. a program that comprises computer-readable instructions, the execution of which by the at least one processor 104 or another computer causes the method to run.

In a first embodiment of the method, the method is described with a first model ƒₕ for predicting the short-term behavior and a second model ƒₗ for predicting the long-term behavior.

In a second embodiment of the method, the method is described with a hybrid model. This hybrid model comprises a learning-based model for predicting the short-term behavior and a physical model for predicting the long-term behavior. The physical model is based on knowledge of the technical system or a part of the technical system.

FIG. 2A shows steps for training the first model ƒₕ and the second model ƒₗ according to the first embodiment.

In a step 200, a state of the technical system 102 is detected and a time series y_{0:n} is provided which comprises values that characterize a course of the state of the technical system 102.

The course of the detected state is determined, for example, for one point in time in each case as a function of an additive superposition of the positions determined for this point in time from the detected signals.

In a step 201, a first filter H(y) is used to determine first filtered values as a function of the values of the time series:

y^{h}=H(y)

In step 201, a second filter is used to determine second filtered values as a function of the values of the time series:

y^{l}=L(y)

The first filter is a complementary filter to the second filter. In this context, complementary means that a reconstruction, or substantially a reconstruction, of an input signal is possible using two signals which result from filtering this input signal with the two filters.

In the example, the first filter is a low-pass filter. In the example, the second filter is a high-pass filter. The low-pass filter has a cutoff frequency. In the example, the high-pass filter has the same cutoff frequency. The high-pass filter can also have a higher cutoff frequency than the low-pass filter.

In the example, a first time series is determined using the first filter, as a function of the time series which represents the temporal course of the state of the technical system 102.

In the example, a filtered time series is determined using the second filter, as a function of the time series which represents the temporal course of the state of the technical system 102.

In a step 202, sampled values are determined by sampling. This reduces the amount of data for training.

In the example, a second time series is determined from the filtered time series at the sampling rate. This means that the second time series comprises values sampled at the sampling rate:

y^{l,d}=y_{0,k,2k, . . .}

In the example, the k-th of the filtered second values are determined at a sampling rate k. The sampling rate k can be reduced to the Nyquist frequency of the filtered time series. This allows the training of a less detailed but robust signal.

In a step 203, the models are trained. For example, the models are trained individually or together. The models can include neural networks that are trained using gradient descent methods, for example.

For example, it is provided that measurement data which describe a sensor measurement value over time are recorded in a laboratory on the physical system 102 using the rotation rate sensor or the acceleration sensor. The models are trained with these measurement data.

The first model ƒₕ is trained as a function of the first time series, wherein

yₙ₊₁^{h}=ƒₕ(yₙ^{h})

The second model ƒₗ is trained as a function of the second time series, wherein

yₙ₊₁^{l,d}=ƒₗ(yₙ^{l,d})

For example, during training, a signal ŷ is decomposed using a pair of complementary filters H and L:

ŷ^{h}=H(ŷ)

ŷ^{l}=L(ŷ)

The signal ŷ^{l} is then sampled at the sampling rate k, i.e. downsampled. One neural network, e.g. separate recurrent networks such as gated recurrent units (GRUs), is trained on each of these components.

During a prediction phase in the training, the two networks are used to learn predictions for y^{h} and y^{l} respectively. The prediction for y^{l} is brought back to the necessary resolution, i.e. upsampled. In the example, the prediction y is determined by adding the two components:

y=H(y^{h})+L(y^{l})

FIG. 2B shows steps for predicting the state of the technical system 102 according to the first embodiment.

Steps 200 to 202 are provided as described above. Step 203 is omitted.

In a step 204, a first value y^{h} for the prediction is determined as a function of the filtered first values.

yₙ₊₁^{h}=ƒₕ(yₙ^{h})

In step 204, at least two predicted values y^{l,d} are determined as a function of the sampled values.

yₙ₊₁^{l,d}=ƒₗ(yₙ^{l,d})

In a step 205, a second value y^{l} for the prediction is determined.

The second value y^{l} is determined as a function of the at least two predicted values yₙ₊₁^{l,d}, in particular by means of interpolation as a function of the sampling rate k.

This means that the second value for the prediction is determined as a function of the filtered second values.

This means that the second value for the prediction is determined as a function of the sampled values.

In a step 206, a value of the prediction is determined as a function of the first value for the prediction and the second value for the prediction.

In the example, the value of the prediction is determined as a function of the sum of the first value for the prediction and the second value for the prediction, e.g.:

y=y^{h}+y^{l}

For example, future values are predicted using given initial values of sensor measurement values of the technical system 102. Corresponding control of the technical system 102 can be subsequently derived therefrom.

FIG. 3A shows steps for training the learning-based model according to the second embodiment.

Steps 300 to 302 are carried out, for example, as described for steps 200 to 202.

It can be provided that the cutoff frequency is determined in a step 301′.

The cutoff frequency is determined, for example, such that the frequency spectra of the simulator and data are similar enough. The simulator assumes these frequencies in the example during the prediction. The corresponding high-pass filter is selected to be complementary.

In a step 303, a part of the hybrid model is trained.

In the example, the learning-based model is trained for the prediction of a first value y^{r}. For example, a recurrent network that produces predictions of the first value y^{r} is trained.

The physical model is designed to determine a second value y^{s} using physical equations.

It can be provided that the hybrid model is trained as a function of a reference value ŷ which is specified in a step 303′.

For example, using the hybrid model, a value y of the prediction is determined

y=H(y^{r})+L(y^{s})

and the learning-based model is trained to minimize a deviation, in particular an L2 norm ∥y−ŷ∥², of this value y from the reference value ŷ. For example, the learning-based model is trained to minimize the deviation between predicted time series and training data.

FIG. 3B shows steps for predicting the state of the technical system 102 according to the second embodiment.

Steps 300 to 302 are carried out, for example, as described for steps 200 to 202. It can be provided that the cutoff frequency is determined in step 301′.

In a step 304, a first value y₁=H(y^{r}) for the prediction is determined, using the learning-based model, as a function of the filtered first values.

In step 305, a second value y₂=H(y^{s}) for the prediction is determined, using the physical model, as a function of the filtered second values.

In a step 306, a value of the prediction y is determined as a function of the first value y₁ for the prediction and the second value y₂ for the prediction.

In the example, the value of the prediction is determined as a function of the sum of the first value for the prediction and the second value for the prediction, e.g.:

y=y₁+y₂

In the learning-based approach according to the first embodiment, predictions are generated that generally show better long-term behavior without losses in short-term behavior. Accumulating errors that can occur in conventional GRUs and LSTMs are avoided, since integration of small model errors is avoided in each step.

By combining low-pass filtering and downsampling, i.e. sampling at the sampling rate k, the second model with stable long-term behavior is obtained. Nevertheless, no information about the modeled signal is lost, because missing information is supplemented by the first model. In addition, these models can often be trained more quickly than standard models. Downsampling the low-pass filter component results in higher computing efficiency, because a smaller number of recurrent steps are executed.

In the hybrid model according to the second embodiment, the different models are combined, exploiting their corresponding strengths. In particular, the long-term behavior of the physical model, i.e., the simulator, can be used, wherein the short-term predictions are improved by the learning-based model, i.e. the use of data. By selecting the filter and in particular its cutoff frequency, previous knowledge about the behavior of the simulator in the frequency space is also used.

1-11. (canceled)

12. A computer-implemented method for predicting a state of a technical system, the method comprising the following steps:
detecting a state of the technical system, and providing a time series which includes values which characterize a course of the detected state of the technical system;
determining, using a first filter, first filtered values for predicting a short-term behavior of the technical system, as a function of the values of the time series;
determining, using a second filter, second filtered values for predicting a long-term behavior of the technical system, as a function of the values of the time series;
determining a first value for the prediction as a function of the filtered first values;
determining a second value for the prediction as a function of the filtered second values; and
determining a value of the prediction as a function of the first value for the prediction and the second value for the prediction.

13. The method according to claim 12, wherein the first filter is a filter that is complementary to the second filter, the first filter being a high-pass filter and the second filter being a low-pass filter.

14. The method according to claim 13, wherein: (i) the low-pass filter has a cut-off frequency, and (ii) the high-pass filter has the cut-off frequency or has a higher cut-off frequency than the low-pass filter.

15. The method according to claim 12, wherein sampled values are determined by sampling a k-th of the filtered second values at a sampling rate k, wherein the second value for the prediction is determined as a function of the sampled values.

16. The method according to claim 15, wherein the first filtered values are mapped to the first value using a first model, wherein the sampled values are mapped to the second value using a second model.

17. The method according to claim 16, wherein the first model is trained as a function of a first time series, wherein the first time series is determined, using the first filter, as a function of a time series which represents a temporal course of the state of the technical system, wherein the second model is trained is a function of a second time series, wherein a filtered time series is determined, using the second filter, as a function of the time series, wherein the second time series includes values sampled from the filtered time series at the sampling rate.

18. The method according to claim 12, the value of the prediction is determined as a function of a sum of the first value for the prediction and the second value for the prediction.

19. The method according to claim 12, wherein a parameter for operation of the technical system or a long-term behavior of the technical system is determined as a function of the prediction.

20. A device configured to predict a state of a technical system, comprising:
at least one processor; and
at least one memory;
wherein the at least one processor is configured to execute machine-readable instructions for predicting a state of a technical system, the instructions, when executed by a processor, causes the processor to perform the following steps:
detecting a state of the technical system, and providing a time series which includes values which characterize a course of the detected state of the technical system,
determining, using a first filter, first filtered values for predicting a short-term behavior of the technical system, as a function of the values of the time series,
determining, using a second filter, second filtered values for predicting a long-term behavior of the technical system, as a function of the values of the time series,
determining a first value for the prediction as a function of the filtered first values,
determining a second value for the prediction as a function of the filtered second values, and
determining a value of the prediction as a function of the first value for the prediction and the second value for the prediction.

21. The device according to claim 20, further comprising:
a sensor configured to detect sensor data or an interface configured to communicate with the sensor for detecting the sensor data, wherein the sensor data include the course of the state of the technical system.

22. A non-transitory computer-readable medium on which is stored a program comprising computer-readable instructions for predicting a state of a technical system, the instruction, when executed by a computer, causing the computer to perform the following steps:
detecting a state of the technical system, and providing a time series which includes values which characterize a course of the detected state of the technical system;
determining, using a first filter, first filtered values for predicting a short-term behavior of the technical system, as a function of the values of the time series;
determining, using a second filter, second filtered values for predicting a long-term behavior of the technical system, as a function of the values of the time series;
determining a first value for the prediction as a function of the filtered first values;
determining a second value for the prediction as a function of the filtered second values; and
determining a value of the prediction as a function of the first value for the prediction and the second value for the prediction.
